(19) United States
(12) Patent Application Publication
(10) Pub. No.: US 2003/0054155 A1
(43) Pub. Date: Mar. 20, 2003

(54) Waterproof, moisture permeable composite film and waterproof, moisture permeable laminate sheet

(76) Inventors: Haruo Nomi, Akaiwa-gun (JP); Yuichiro Nozaki, Okayama-city (JP)

Correspondence Address: W. L. Gore & Associates, Inc., 551 Paper Mill Road, P.O. Box 9206, Newark, DE, 19714-4880, US

(21) Appl. No.: 09/853,829

(22) Filed: May 11, 2001

(30) Foreign Application Priority Data
May 12, 2000 (JP) 2000-140616

(51) Int. Cl. B32B 3/06

(52) U.S. Cl. 428/306.6; 442/370; 428/319.3

(57) ABSTRACT

A waterproof, moisture permeable composite film from 7 to 300 μm in thickness and comprising a porous hydrophobic film having a coating layer of a hydrophilic resin produced on one face thereof; wherein said hydrophilic resin coating layer is a thin film having depth such that when an electron microscopic image of the surface of said hydrophilic resin coating layer taken at 10,000× magnification with an electron microscope is viewed with the naked eye, the contours of said porous hydrophobic film matrix are visible through said hydrophilic resin coating layer over at least a portion of said hydrophilic resin coating layer; and wherein pores present on the surface of said porous film on the side thereof having the coating layer are infiltrated by hydrophilic resin continuous with said coating layer, while the surface of said porous film on the side thereof devoid of coating layer is not infiltrated by said hydrophilic resin and retains a porous structure, such that the composite film has water vapor transmission of at least 5000 g/m²·24 h.

### BACKGROUND OF THE INVENTION

1. Field of the Invention

The present invention relates to a waterproof, moisture permeable composite film and a waterproof, moisture permeable laminate sheet, for use in raingear, sportswear, tents, sleeping bags, tarps, and similar articles.

2. Description of Related Art

Waterproof sheet materials employed in the manufacture of raingear and sportswear are typically both waterproof and impervious to water vapor. In the case of raingear, garments are fabricated from waterproof, moisture permeable sheet materials to prevent rainwater from penetrating the garment during rainstorms, as well as to allow water vapor evaporating from perspiration produced by the human body during wear to move from the inside of the garment, where vapor pressure is higher, to the outside, where vapor pressure is lower. This provides a comfortable, non-sticky environment within the garment. Other qualities important in raingear besides waterproofness and moisture permeability are light weight; ability to be folded into a compact package; ability to withstand mechanical stresses such as friction, abrasion, and scratching; and ability to withstand chemical stresses such as ultraviolet or those occurring with soiling and laundering.

Patent Publication (Kokoku) 51-18991 (Citation 1) discloses a porous polytetrafluoroethylene film (porous PTFE film). Lamination of fabric to one or both sides of this porous PTFE film by means of spot adhesion for use as a waterproof, moisture permeable material is known art.

Patent Publication (Kokoku) 60-39014 (Citation 2) discloses a composite film. This composite film is composed of porous PTFE film whose surface voids on one face are infiltrated by a hydrophilic polyurethane resin.

Patent Publication (Kokoku) 7-10935 (Citation 3) discloses a composite film. This composite film is composed of a microporous polymer matrix filled with hydrophilic resin.

U.S. Pat. No. 2,582,082 (Citation 4) discloses a composite film. This composite film is composed of a porous hydrophobic film whose pores on one face thereof are closed off by a hydrophilic material, leaving the hydrophobic material exposed in the pores interstices, while at the other face thereof the pore are substantially devoid of hydrophilic material.

The porous PTFE film of Citation 1, however, has problems in terms of durable waterproofness. The porous PTFE film can have void content as high as 80 to 95%, making it extremely moisture permeable and pliable while having good strength in the x and y directions. However, strength in the z direction (thickness direction) is poor, and there are problems with ability to withstand friction and abrasion. The porous PTFE film has low surface energy, making it water- and oil-repellent, but once soil has penetrated into the material under the action of pressure, temperature, or other factors, it is not easily removed due to static electrical bonding. Since most soils are hydrophilic, the soiled porous PTFE film becomes hydrophilic as well, lowering waterproofness.

The composite film of Citation 2 teaches coating one face of hydrophobic porous PTFE film with a hydrophilic polyurethane resin to prevent it from becoming soiled by perspiration or sebum, and thus losing waterproofness. However, while this porous PTFE film offers improved resistance to soiling of the porous PTFE film, resistance is not yet wholly satisfactory. This is due to the fact that the polyurethane resin layer provided to one face of the porous PTFE film protrudes out significantly from the porous PTFE film surface. Polyurethane resin protruding from the porous PTFE film creates appreciable frictional resistance, creates external stress concentrations and susceptibility to damage, and tends to swell by absorbing perspiration and rainwater during wear. The swelled resin loses mechanical strength, has lowered resistance to abrasion and flexure, and in the swelled state is easily damaged, resulting in a loss of waterproofness. In actual practice, waterproof, moisture permeable garments employing this composite film are limited to use thereof in the form of a woven fabric/composite film/knit fabric triple-layer laminate sheet as a base material by itself, or in the form of a base material of a woven fabric/composite film double-layer laminate sheet having protective fabric (liner material) arranged thereon, so that the mechanical strength of the composite film is supplemented by the woven fabric or liner material. Water repellent, moisture permeable garments of this design have better soil resistance than the waterproof, moisture permeable garment of Citation 1, but have limits in terms of the extent to which weight can be reduced while assuring durability, and the extent to which moisture permeability and comfort of garments can be improved by reducing the thickness of the material. The triple-layer laminate sheet has a stiffer hand of the base material than does the double-layer laminate sheet, and frictional noise during wear is quite noticeable. Where the base material consists of a liner material arranged on a double-layer laminate sheet, drawbacks include frictional noise produced by rubbing together of the liner material and the composite film of the double-layer laminate sheet during wear; damage of the composite film due to abrasion by the liner material; and discomfort due to clinging of the liner material to the body during wear.

In the composite film of Citation 3 there is substantially no protrusion of hydrophilic resin from the microporous polymer matrix, which has the advantage that the hydrophilic resin resists wear and separation. However, since the hydrophilic resin completely impregnates the microporous polymer matrix of the composite film, the hydrophilic resin is relatively thick, and may depress moisture permeability. Where porous PTFE film is used as the microporous polymer matrix, the porous PTFE film tends to lose its inherent pliability when the porous PTFE film is completely impregnated with hydrophilic resin, the film tends to experience pinhole formation due to mechanical stress, and there are problems with the waterproofness and durability of the composite film.

The composite film of Citation 4 has a design that prevents the hydrophilic material from protruding from the surface of the hydrophobic porous film, which has the advantage that the hydrophilic resin resists delamination from the hydrophobic material. However, the composite film needs improvement in terms of moisture permeability, ease of condensation, and adhesion of sealing tape. The design of this composite film is such that the hydrophobic material lies exposed at the hydrophilic material side of the composite film, so moisture permeable area is essentially limited to the hydrophilic material portions, creating the problem of lowered moisture permeability. When water vapor migrates through the laminate sheet from the higher vapor pressure environment within the garment to the lower vapor pressure environment outside the garment, the water vapor is transported through the hydrophilic material by means of penetration and diffusion into the hydrophilic material from the hydrophilic material surface; with the design of the composite film of Citation 4, however, the effective film surface area over which water vapor can penetrate and diffuse into the hydrophilic material is limited to the pores where hydrophilic material is present. Further, since the hydrophobic material lies exposed on the composite film surface, condensation is more likely to form than is the case where a hydrophilic material is exposed over the entire face of the material. Additionally, in the case of raingear, seams are typically covered with hot-melt type sealing tape to seal them; where the hydrophobic material lies exposed on the face to which sealing tape is to be bonded, tape adhesion can be a problem. Further, the composite film of Citation 4 is essentially predicated on melt extrusion of molten resin such as polyethylene or polypropylene, making it difficult to produce the composite film structure of Citation 4 when using porous PTFE film or the like (Citation 4 does not teach a specific fabrication process other than melt extrusion).

These and other purposes of the present invention will become evident from review of the following specification.

### SUMMARY OF THE INVENTION

It is an object of the present invention to provide a material that is light weight and possesses both waterproofness/moisture permeability and durability. The inventors perfected the invention as the result of extensive research directed towards solving this problem.

Specifically, the invention provides a waterproof, moisture permeable composite film from 7 to 300 μm in thickness and comprising a porous hydrophobic film having a coating layer of a hydrophilic resin produced on one face thereof; wherein said hydrophilic resin coating layer is a thin film having depth such that when an electron microscopic image of the surface of said hydrophilic resin coating layer taken at 10,000× magnification with an electron microscope is viewed with the naked eye, the contours of said porous hydrophobic film matrix are visible through said hydrophilic resin coating layer over at least a portion of said hydrophilic resin coating layer; and wherein pores present on the surface of said porous film on the side thereof having the coating layer are infiltrated by hydrophilic resin continuous with said coating layer, while the surface of said porous film on the side thereof devoid of coating layer is not infiltrated by said hydrophilic resin and retains a porous structure, such that the composite film has water vapor transmission of at least 5000 g/m²·24 h.

The invention further provides a waterproof, moisture permeable laminate sheet comprising: said waterproof, moisture permeable composite film; and fabric laminated to the hydrophobic face thereof.

The invention further provides a waterproof, moisture permeable laminate sheet comprising: said waterproof, moisture permeable composite film; and fabric laminated to both faces thereof.

The present waterproof, moisture permeable laminate sheet provides a waterproof, moisture permeable composite film and waterproof, moisture permeable laminate sheet having reduced frictional resistance on the coated faces of the waterproof, moisture permeable composite film, thereby affording reduced propagation of external stresses that can lower waterproofness and reducing the likelihood of surface damage, and which, as the hydrophilic resin is protected by the hydrophobic porous film structure from mechanical stresses and environmental stresses accompanying degradation with time, such as swelling due to moisture, experience no loss of moisture permeability and are durable. Such durability is achieved even with a double-layer waterproof, moisture permeable laminate sheet composed of waterproof, moisture permeable composite film/woven fabric laminate, and raingear fabricated thereof will be lighter in weight and more compact than raingear fabricated of conventional triple-layer laminate sheet materials.

### DESCRIPTION OF THE DRAWINGS

The operation of the present invention should become apparent from the following description when considered in conjunction with the accompanying drawings, in which:

FIG. 1 is an electron microscope image of the coated face of the waterproof, moisture permeable composite film of Example 1, taken with an electron microscope at 3000× magnification.

FIG. 2 is an electron microscope image of the coated face of the waterproof, moisture permeable composite film of Example 1, taken with an electron microscope at 5000× magnification.

FIG. 3 is an electron microscope image of the coated face of the waterproof, moisture permeable composite film of Example 1, taken with an electron microscope at 10000× magnification.

FIG. 4 is an electron microscope image of the surface of the porous PTFE film used in Example 1, taken with an electron microscope at 3000× magnification.

FIG. 5 is an electron microscope image of the surface of the porous PTFE film used in Example 1, taken with an electron microscope at 5000× magnification.

FIG. 6 is an electron microscope image of the surface of the porous PTFE film used in Example 1, taken with an electron microscope at 7000× magnification.

FIG. 7 is an electron microscope image of the coated face of the waterproof, moisture permeable composite film of Comparative Example 1 (Citation 2), taken with an electron microscope at 3000× magnification.

### DETAILED DESCRIPTION OF THE INVENTION

The porous hydrophobic film herein may consist of materials of porous structure known in the art, for example, open-celled hydrophobic materials of synthetic resins, such as porous polyolefin resins or porous fluororesins. Where the film consists of open-celled polyolefin resin (e.g. polyethylene or polypropylene), it may be imparted with water repellency by treatment with a fluorine based water repellent or silicone based water repellent. Porous fluororesins herein include porous polytetrafluoroethylene, tetrafluoroethylene/hexafluoropropylene copolymer, polyvinyl fluoride, polyvinylidene fluoride, and similar materials; porous polytetrafluoroethylene film (porous PTFE film) produced by expanding polytetrafluoroethylene is especially preferred for its high void content, pliability, strong hydrophobicity, chemical resistance, and heat resistance.

Maximum pore size of the porous hydrophobic film is from 0.01 to 10 μm, and preferably from 0.1 to 1 μm. Porous hydrophobic films with maximum pore size smaller than 0.01 μm are difficult to produce, while conversely pore size larger than 10 μm may result in diminished waterproofness, as well as lower film strength posing difficulties in secondary processes such as coating and lamination. Porous hydrophobic film void content is from 50 to 98%, and preferably from 60 to 95%. Maximum pore size is measured by the method prescribed in ASTM F-316, and void content is determined by measuring apparent density in accordance with JIS K 6885, computing void content from apparent density (ρ) using the following equation.

void content (%)=(2.2−ρ)/2.2×100 (1)

Porous hydrophobic film void content below 50% results in diminished moisture permeability of the composite film produced by coating with hydrophilic resin, while that exceeding 98% results in diminished film strength.

Porous hydrophobic film thickness is from 7 to 300 μm, and preferably from 10 to 100 μm. Porous hydrophobic films thinner than 7 μm pose difficulties in processing during production, while those thicker than 300 μm lose pliability and experience diminished moisture permeability. Film thickness herein is average thickness measured with a dial gauge (measured with 1/1000 mm dial thickness gauge ex TechnoLock, in an unloaded state apart from the spring load).

In preferred practice, the porous hydrophobic film herein will have its pore interior surfaces coated with a water repellent, oil repellent polymer. This polymer may contain fluorine side chains. A polymer of this kind and a process for compounding thereof with porous film are described in detail in WO 94/22928; an example is given below.

Suitable polymers for coating include fluoropolymers (ideally those whose fluorinated alkyl moiety has from 6 to 16 carbons) polymerized from fluoroalkyl acrylates and/or from fluoroalkyl methacrylates given by general formula (1):

### Chemical Formula 1

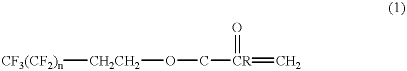

(wherein n is an integer from 3 to 13, and R is hydrogen or methyl). The process for coating the inside surfaces of the pores of the porous film with the polymer is to prepare an aqueous micro-emulsion (mean particle size 0.01 to 0.5 μm) of the polymer using a fluorine based surfactant (e.g., ammonium perfluorooctanoate), impregnate this into the pores of the porous film, and then heat. This removes the water and fluorine based surfactant, and causes the fluoropolymer to fuse and coat the pore interior surfaces of the porous film, producing a porous film endowed with excellent water- and oil-repellency while retaining its open-celled structure. Other polymers, such as TEFLON AF polymer (trade name of DuPont) or CYTOP (trade name of Asahi Glass), may be used as well. In an alternative process for coating the pore interiors of the porous polymer film with a polymer, the polymer is dissolved in an inert solvent, such as FLUORINERT (trade name of 3M), impregnated into the pores of the porous polymer film, and the solvent then evaporated.

Coating the inside surfaces of the pores in a film of porous PTFE or other porous material with the organic polymers mentioned above enables the porous film to resist penetration of soils if the porous film should become soiled by soils of various kinds, and prevents the porous film from losing hydrophobicity as a result.

The hydrophilic resin used herein is a polymer material containing hydrophilic groups such as hydroxyl, carboxyl, sulfonic, or amino groups. In preferred practice, it will be water swelling but insoluble in water. Specific examples are partially crosslinked polyvinyl alcohol, cellulose acetate, cellulose nitrate, and other hydrophilic polymers, as well as hydrophilic polyurethane resins; hydrophilic polyurethane resins are especially preferred for its heat resistance, chemical resistance, processability, and moisture permeability.

The hydrophilic polyurethane resins herein include polyester- or polyether-based polyurethanes (or prepolymers) containing hydroxyl, amino, carboxyl, sulfonic, oxyethylene, or other hydrophilic groups; the melting point (softening point) of the resin can be controlled using a crosslinker such as a diisocyanate or triisocyanate having two or more isocyanate groups, or adducts thereof, either individually or in combination. For isocyanate-terminated prepolymers, curing agents such as polyfunctional dipolyols, tripolyols, diamines, and triamines may be used. Bifunctional compounds are preferred over trifunctional ones so as to maintain a high level of moisture permeability.

In an exemplary process for impregnating the porous structure of a porous film of porous PTFE or other material with hydrophilic resin—such as hydrophilic polyurethane resin—, a (poly)urethane resin, for example, is prepared as a coating liquid either by dissolving it in a solvent or melting it with heat, and this liquid is then applied onto the porous PTFE film with a roll coater or similar means. The viscosity of the coating liquid used for impregnation is appropriately ≦20,000 cps, and preferably ≦10,000 cps, at coating temperature. Where a solvent has been used to prepare a solution, there is a risk —depending in part on solvent composition—that if viscosity is too low the solution will diffuse throughout the entire porous PTFE or other porous film once coated thereon, thereby rendering the material hydrophilic overall; since this increases the likelihood of problems with waterproofness, viscosity should be maintained at a minimum of 500 cps. Viscosity measurements are made with a Brookfield type viscometer from Toki Sangyo. However, as impregnatability of a porous structure of porous PTFE or other porous film by hydrophilic polyurethane resins or other hydrophilic resins will vary somewhat with factors such as surface tension, pore size, temperature, and pressure, parameters must be selected appropriately so that the hydrophilic polyurethane resin or other hydrophilic resin impregnates the porous PTFE film but does not diffuse throughout the entire film, in order that the hydrophilic polyurethane resin or other hydrophilic resin may form a thin coating on the surface of the porous PTFE film. The viscosity values for coating solutions containing the hydrophilic polyurethane resin or other hydrophilic resins mentioned herein are effective for porous PTFE or other porous films with mean pore size of 0.2 μm.

In preferred practice, the impregnating layer of hydrophilic resin will have depth such that when an electron microscopic image taken of the thinly coated portions of the hydrophilic resin (i.e., portions in which the hydrophilic resin protrudes from the porous PTFE or other hydrophilic resin porous film surface) —these thinly coated portions being imaged at 10,000× magnification—is viewed with the naked eye, the contours of the porous film matrix are visible through the hydrophilic resin coating layer over at least a portion of the hydrophilic resin coating layer. If the thinly coated portions are so thick that the contours of the porous film matrix are not visible through the hydrophilic resin coating layer, the surface will develop high frictional resistance, and the material will become susceptible to external stresses, lowering resistance to abrasion and flexure so that waterproofness is not adequately sustained. On the other hand, if the porous film is devoid of thin film and left exposed, moisture permeability is depressed, condensation tends to form on composite film surfaces, and there are problems with adhesion of sealing tape.

In terms of moisture permeability, pliability (hand), and durability, the depth of penetration of hydrophilic resin into the porous film is preferably from 5 to 30 μm, and ideally 10 to 25 μm. Durability is too poor for practical purposes where depth is less than 5 μm, while depth exceeding 30 μm produces an unacceptable drop in moisture permeability. The depth of penetration of polyurethane resin into the porous film is determined by measuring average depth with the naked eye from sectional images (at 1000-3000×) made by an electron microscope, using the scale (markings indicating length) of the electron microscope images. In portions thinly coated with hydrophilic resin, depth is difficult to measure from sectional images made by an electron microscope due to their extreme thinness; however, the working effects of the invention are achieved provided that a hydrophilic resin coating layer is present on the porous film surface such that least portions of the hydrophilic resin coating layer are thin enough for the contours of the porous film matrix to be visible through it when an electron microscopic image taken at 10,000× magnification of the thinly coated portion is viewed with the naked eye. In preferred practice, the hydrophilic resin impregnating the pores will have a melting point (softening point) of at least 150° C. so as to prevent the coated surfaces from fusing together when, for example, a garment made from the material is tumble dried after laundering, or left in a hot car during the summer.

The fabric used herein may be selected from all manner of materials functioning as a protective layer for the waterproof, moisture permeable composite film; however, woven fabrics, knit fabrics, nonwoven fabrics, or netting composed of synthetic or natural fibers are preferred. Preferred synthetic fibers include polyamide, polyester, polyurethane, polyolefin, polyvinyl chloride, polyvinylidene chloride, polyfluorocarbon, and polyacrylic fibers. Preferred natural fibers include cotton, hemp, animal hair, and silk fibers. Woven fabrics or knit fabrics of nylon or polyester are especially preferred for their aesthetic appeal, strength, and durability.

When laminating fabric to the waterproof, moisture permeable composite film, it is preferable to laminate the fabric to the hydrophobic porous film face of the waterproof, moisture permeable composite film to produce a double-layer structure. Where this waterproof, moisture permeable composite sheet of double-layer structure is used for an article of raingear, the fabric side faces outward and the hydrophilic resin face of the composite film faces the body. The waterproof, moisture permeable laminate sheet herein possesses both strength and durability sufficient for practical purposes, obviating the need for liner materials used conventionally to provide reinforcement. Since the fabric side of the material is exposed on the outside of the article of raingear, in preferred practice it will consist of woven fabric so as to provide aesthetic appeal and strength. If the fabric located on the outside surface should absorb water, a film of water will form on the surface of t:he article of raingear, lowering the moisture permeability of the waterproof, moisture permeable laminate sheet and causing the sheet to become heavier and less comfortable; for this reason it is preferable to treat the fabric with a fluorine based or silicone based water repellent.

In another aspect, when laminating fabric l:o the waterproof, moisture permeable composite film, fabric may be laminated to both faces of the waterproof, moisture permeable composite film to produce a triple-layer structure. This method is particularly effective where the waterproof, moisture permeable laminate sheet will be used for industrial raingear, tents, tarps, and similar articles. For articles of raingear, it is preferable to laminate woven fabric to the hydrophobic porous film face of the waterproof, moisture permeable composite film, and knit fabric to the hydrophilic resin face thereof. Where this waterproof, moisture permeable composite sheet of triple-layer structure is used for an article of raingear, the woven fabric side should face outward. By having the knit fabric side serve as the inside it is possible to facilitate adhesion of sealing tape used for seams on the inside of t:he article of raingear. Woven fabrics can be suitably selected from materials having softness and light weight, and thus not only serve to protect the waterproof, moisture permeable composite film, but also contribute to the waterproof, moisture permeable laminate sheet that is light weight and has soft hand.

In preferred practice, the hydrophilic resin face of the waterproof, moisture permeable composite film will be located on the knit fabric side (body side) so as to provide good moisture permeability and durability. If the hydrophobic porous film face is arranged on the body side, water vapor evaporating from the body will permeate into th(e pores on the hydrophobic porous film surface, adhere to the hydrophilic resin infiltrating the pores, and penetrate/diffuse through the hydrophilic resin; since, on the face of the material at which water vapor adheres and penetrates, the effective area of the hydrophilic resin on the face is essentially limited to the pores, moisture permeability will be lower than is the case where the hydrophilic resin face is arranged on the body side. An additional advantage of situating the hydrophilic resin face on the body side is that the hydrophilic resin face reduces soils such as perspiration or sebum produced by the body, preventing the hydrophobic porous film from becoming soiled thereby.

Lamination of fabric to the waterproof, moisture permeable composite film may be accomplished using methods known in the art. For example, a urethane adhesive may be applied to the waterproof, moisture permeable composite film with a gravure patterned roll, arranging fabric thereover and compressing with a roll; a urethane adhesive may be sprayed onto the waterproof, moisture permeable composite film, arranging fabric thereover and compressing with a roll; or the waterproof, moisture permeable composite film and fabric may be juxtaposed and thermal fused with heat rolls. The area of adhesion (or fusion) produced by lamination in the preceding manner should be 3 to 90%, and preferably 5 to 80%. Where the adhesion (or fusion) area is less than 3% there will not be adequate adhesive strength between the waterproof, moisture permeable composite film and the fabric, while moisture permeability of the waterproof, moisture permeable laminate sheet tends to drop above 90%.

The invention provides a structure whereby the advantages of porous film (such as porous PTFE film) and of hydrophilic resins (such as hydrophilic polyurethane resin) may be expressed to the greatest degree possible. Specifically, skillful combination of porous PTFE film—which has excellent chemical resistance (chemical inertness) and good strength in the x and y directions, but poor mechanical strength in the z direction (thickness direction)—with hydrophilic resins such as hydrophilic polyurethane resin—which has excellent wear resistance but poor moisture permeability and chemical resistance, and a tendency to degrade with time—provides for the first time materials that excel in all the qualities required of waterproof, moisture permeable materials. Specifically, by means of impregnating a porous film lacking mechanical strength in the z direction with hydrophilic resin having excellent wear resistance, it is possible to compensate for the lack of mechanical strength in the z direction of the porous film. On the other hand, by substantially incorporating within a porous film structure a hydrophilic resin having excellent wear resistance but high frictional resistance, the coefficient of surface friction of the hydrophilic urethane resin may be reduced. This in turn reduces propagation of externally impinging friction or mechanical stresses which can cause tearing, thereby lowering the risk of surface damage that could result in leaking of the waterproof layer. Swelling of the hydrophilic resin layer due to moisture—the instigating factor of deterioration in waterproofness—can be controlled by having the hydrophilic resin retained impregnating a hydrophobic porous structure that is stable with respect to moisture, thereby reducing swelling of the hydrophilic resin component—which is subjected directly to external stresses—and lessening the risk of damage to the hydrophilic resin by moisture. In addition, the mechanical strength of the porous film in the x and y directions increases the overall resistance of the film to mechanical stress. By means of this characteristic composite structure, a durable hydrophilic resin layer can be achieved with thicknesses of 30 μm or less, in turn allowing moisture permeability to be increased by making the hydrophilic resin layer thinner. An additional advantage is that thinner hydrophilic resin layers are less likely to include voids.

The waterproof, moisture permeable composite film herein has water vapor transmission of at least 5000 g/m²·24 h, and preferably at least 10,000 g/m²·24 h. The upper limit is typically 70,000 g/m²·24 h. Water vapor transmission is calculated by converting measurements made in accordance with JIS L 1099B-2 into 24-hour values.

The wear resistance of a sheet composed of the waterproof, moisture permeable composite film herein having laminated to the hydrophobic face thereof fabric (100% nylon, 70 deniers, plain weave, density: warp 120 threads/inch, weft: 90 threads/inch) is such that when this laminate sheet sample is placed on the abrasive fabric support of a Martindale abrasion tester in abrasion mode with a standard wool abrasive fabric attached to the sample holder, and the hydrophilic resin face thereof is abraded 1000 times under a 12 KPa load, then subjecting the laminate sheet from the fabric side thereof to 1000 mm water column pressure for 60 seconds—each such operation constituting one cycle—the number of cycles occurring before the laminate sheet starts to leak water is 10 or more (i.e., 100,000 abrasion strokes or more), and preferably 30 or more (i.e., 300,000 abrasion strokes or more). Laminate sheet water vapor transmission of at least 3000 g/m²·24 h, and preferably at least 7000 g/m²·24 h. The upper limit is typically 50000 g/m²·24 h.

### EXAMPLES

A fuller understanding of the invention is provided through the following non-limiting examples.

### Example 1

A coating solution was prepared by dissolving 100 parts by weight of polyether polyurethane (a polyurethane consisting of diphenylmethane diisocyanate and a polyol, containing from 60% to 65% oxyethylene groups on a weight basis) and 5 parts by weight of a trifunctional tolylene diisocyanate adduct in a mixed solvent consisting of 50 parts by weight of dimethylformamide and 50 parts by weight of xylene (viscosity: 4000 cps at 25° C.).

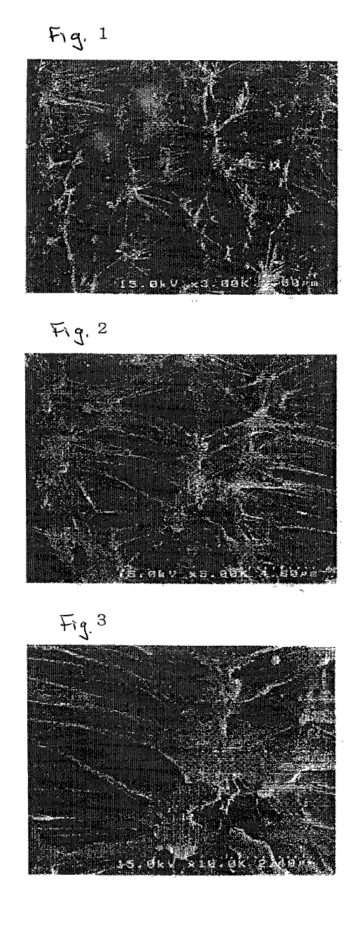

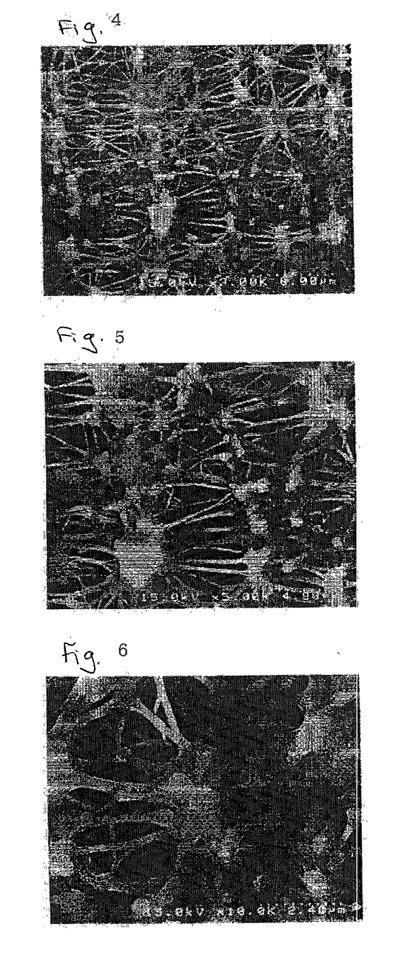

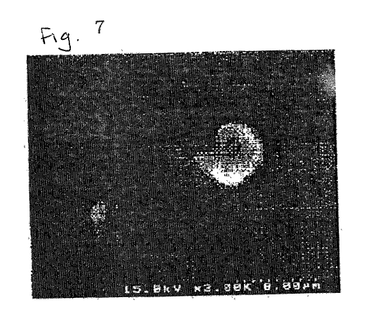

This coating solution was applied onto porous PTFE film (void content 80%, mean pore size 0.2 μm, average thickness 30 μm) with a roll coater. The force of the roll coater was adjusted so that most of the applied solution was absorbed into the porous PTFE film, with only a scant amount remaining on the surface. The material was then dried for 5 minutes at 100° C. and heat treated for 10 minutes at 160° C. The coated face (i.e. surface) of the resultant composite film was imaged at 3000-10000× magnification under an electron microscope, and the electron microscope images were examined with the naked eye. It was found that a thin coating film of polyurethane resin had formed over the entire coated face, and that in portions the polyurethane resin coating was thin enough that the contours of the porous PTFE film matrix were visible through it. Electron microscope images are shown in FIGS. 1 to 3. For purposes of comparison, electron microscope images (surface images) at the same magnifications taken of the porous PTFE film prior to coating with polyurethane resin are shown in FIGS. 4 to 6. The polyurethane resin layer on the resultant composite film was 18 μm deep in the areas of penetration thereof into the porous PTFE film. Here and in the following examples, depth of the polyurethane resin in the areas of penetration thereof into the porous PTFE film was determined by measuring average depth with the naked eye from sectional images (at 1000-3000×) made by the electron microscope, using the scale (markings indicating length) of the electron microscope images. Composite film water vapor transmission was 20,000 g/m²·24 h. Here and in the following examples, water vapor transmission is calculated by converting measurements made in accordance with JIS L 1099B-2 into 24-hour values.

This film and a fabric (100% nylon, 70 deniers, plain weave, density: warp 120 threads/inch, weft: 90 threads/inch) were laminated together by means of spot adhesion (adhesive coverage 40%) using a polyester-based polyurethane adhesive system with a trimethylolpropane tolylene diisocyanate adduct curing agent (conducting adhesion on the uncoated face) to produce a laminate sheet. Heat treatment during lamination was conducted for 5 minutes at 150° C.

### Example 2

A coating solution was prepared by adding ethylene glycol to hydrophilic polyurethane resin (HYPOL 2000, trade name of Dow Chemical) in a proportion such that the NCO/OH equivalent ratio was 1, adding toluene until the polyurethane prepolymer concentration reached 90% on a weight basis, and then stirring to mix. This coating solution was applied onto porous PTFE film (void content 80%, mean pore size 0.2 μm, average thickness 40 μm) with a roll coater. The force of the roll coater was adjusted so that most of the applied coating solution was absorbed into the porous PTFE film, with only a scant amount remaining on the surface. The material was then dried for 5 minutes at 100° C. and conditioned for 60 minutes at 100° C., 100% RH. The coated face (i.e. surface) of the resultant composite film was imaged at 3000 -10000× magnification under an electron microscope, and the electron microscope images were examined with the naked eye. It was found that a thin coating film of polyurethane resin had formed over the entire coated face, and that in portions the polyurethane resin coating [was thin enough] that the contours of the porous PTFE film matrix were visible through it. The polyurethane resin layer on the resultant composite film was 28 μm deep in the areas of penetration thereof into the porous PTFE film. Composite film water vapor transmission was 18000 g/m²·24 h.

A laminate sheet was then prepared by the same process as in Example 1, using identical nylon taffeta.

### Example 3

A coating solution was prepared by dissolving 100 parts by weight of polyether polyurethane (a polyurethane consisting of diphenylmethane diisocyanate and a polyol, containing from 60% to 65% oxyethylene groups on a weight basis) and 5 parts by weight of a trifunctional tolylene diisocyanate adduct in a mixed solvent consisting of 50 parts by weight of dimethylformamide and 50 parts by weight of xylene. Separately, carbon black and 2000-molecular weight polypropylene glycol were combined in amounts such that the carbon black content was 20% on a weight basis, and this mixture was kneaded thoroughly in a 3-roll mill to produce a black pigment paste. The polyether polyurethane and black pigment paste were combined in a 100/5 ratio by weight, and mixed thoroughly to produce a coating solution. A black composite film was then produced following the same procedure as in Example 1. The coated face (i.e. surface) of the resultant composite film was imaged at 3000-10000× magnification under an electron microscope, and the electron microscope images were examined with the naked eye. It was found that a thin coating film of polyurethane resin had formed over the entire coated face, and that in portions the polyurethane resin coating was thin enough that the contours of the porous PTFE film matrix were visible through it. The polyurethane resin layer on the resultant composite film was 17 μm deep in the areas of penetration thereof into the porous PTFE film. Composite film water vapor transmission was 22000 g/m²·24 h.

A laminate sheet was then prepared by the same process as in Example 1, using identical nylon taffeta.

### Example 4

A triple-layer laminate sheet was prepared from the double-layer laminate sheet of Example 1 by laminating to the coated face thereof a knit (100% nylon, 20 deniers, plain weave, 28 gauge tricot half), by means of spot adhesion (adhesive coverage 40%) using a polyester-based polyurethane adhesive system with a trimethylolpropane tolylene diisocyanate adduct curing agent (conducting adhesion on the uncoated face) to produce a laminate sheet. Heat treatment during lamination was conducted for 5 minutes at 150° C.

### Comparative Example 1

Using a coating solution and porous PTFE:- film identical to those in Example 1, a coating process was performed while reducing the force of the roll coater so that coating solution remained on the film surface. The material was then dried and conditioned under the same Conditions as in Example 1 to produce a composite film similar to the composite film taught in Citation 2. The coated face (i.e. surface) of the resultant composite film was imaged at 3000-1000× magnification under an electron microscope, and the electron microscope images were examined with the naked eye. It was found that a coating film of polyurethane resin had formed over the entire coated face, and the contours of the porous PTFE film matrix were completely concealed thereby. The electron microscope image is shown in FIG. 7. The polyurethane resin layer on the resultant composite film was 12 μm deep in the areas of penetration thereof into the porous PTFE film. Composite film water vapor transmission was 20,000 g/m²·24 h. A laminate sheet was then prepared by the same process as in Example 1, using identical nylon taffeta.

### Comparative Example 2

Using a coating solution identical to those in Example 1 and an expanded porous polytetrafluoroethylene film, a coating process was performed while increasing the force of the roll coater so that coating solution impregnated the entire film. The material was then dried and conditioned under the same conditions as in Example 1 to produce a composite film. The polyurethane resin layer on the resultant composite film completely impregnated the porous PTFE film. The resultant composite film had water vapor transmission of 4000 g/m²·24 h.

A laminate sheet was then prepared by the same process as in Example 1, using identical nylon taffeta.

### Comparative Example 3

A coating solution was prepared from coating material identical to that in Example 2, but without using the toluene solvent. The coating solution was applied onto a porous PTFE film identical to that in Example 2, adjusting the force of the roll coated so that the coating solution did not impregnate the porous PTFE film. The material was then dried and conditioned under the same conditions as in Example 2 to produce a composite film. The polyurethane resin layer on the resultant composite film was 27 μm deep in the areas of projection thereof from the porous PTFE film, and 3 μm deep in the areas of penetration thereof into the porous PTFE film. Polyurethane resin layer depth in the areas of projection thereof from the porous PTFE film and areas of penetration thereof into the porous film were determined by measuring average depth with the naked eye from sectional images (at 1000-3000×) made by an electron microscope, using the scale, (markings indicating length) of the electron microscope images. Composite film water vapor transmission was 21000 g/m²·24 h.

A laminate sheet was then prepared by the same process as in Example 2, using identical nylon taffeta.

### Comparative Example 4

A coating solution was prepared from coating material identical to that in Example 2, adding toluene solvent in an amount such that polyurethane prepolymer concentration reached 50% on a weight basis, and was then applied to porous PTFE film identical to that in Example 2. The material was then dried and conditioned under the same conditions as in Example 2 to produce a composite film. The polyurethane resin layer of the resultant composite film completely impregnated the interior of the porous PTFE film. The resultant composite film had water vapor transmission of 4400 g/m²·24 h.

A laminate sheet was then prepared by the same process as in Example 2, using identical nylon taffeta.

### Comparative Example 5

Porous PTFE film identical to that used in Example 1, but not impregnated with hydrophilic polyurethane resin, was laminated with nylon taffeta under the same bonding conditions as in Example 2.

### Comparative Example 6

A triple-layer laminate sheet was prepared from the double-layer laminate sheet of Comparison 1 by laminating to the coated face thereof a knit (100% nylon, 20 deniers, plain weave, 28 gauge tricot half), by means of spot adhesion (adhesive coverage 40%) using a polyester-based polyurethane adhesive system with a trimethylolpropane tolylene diisocyanate adduct curing agent (conducting adhesion on the uncoated face) to produce a laminate sheet. Heat treatment during lamination was conducted for 5 minutes at 150° C.

### Test Results

The properties of the laminate sheets prepared from nylon taffeta and the composite films fabricated in the preceding Examples and Comparative Examples were measured as follows. Results are tabulated in Tables 1 and 2.

### (1) Water Vapor Transmission

JIS L 1099B-2 method (converted to 24 h)

### (2) Abrasion Test

Using the Martindale abrasion tester stipulated in JIS L 1096 in abrasion mode, with the laminate sheet placed on the abrasive fabric support and a standard wool abrasive fabric attached to the sample holder, the coated face (for triple layer sheets, the knit face) is abraded with standard wool abrasive fabric under a 12 KPa load. After each 1000 strokes, the laminate sheet is subjected from the taffeta side thereof to 1000 mm water column pressure for 60 seconds, examining the material for leaks. After inspecting the laminate sheet for leaks, the material is dried for 30 minutes with 80° C. hot air before proceeding to the next abrasion cycle. Materials3 leaking at two or more locations were designated as “fail” (leaky).

### (3) Scratch Test

A 0.05 R sapphire stylus is installed in a Shinto Kagaku surface property measuring unit according to JIS K 6718, placed under a prescribed load, and drawn across the coated face (for triple layer sheets, the knit face) of the sample at a speed of 1000 mm/min, for a distance of 50 mm. The laminate sheet is subjected from the taffeta side thereof to 1000 mm water column pressure for 60 seconds, examining the material for leaks. Materials leaking at two or more locations are designated as “fail” (leaky).

### (4) SUS Ball Abrasion Test

A 3.17 φ USU ball is installed in a Shinto Kagaku surface property measuring unit according to JIS K 6718, placed under a 200 g load, and drawn across the coated face (for triple layer sheets, the knit face) of the sample at a speed of 1000 mm/min, for a distance of 50 mm. After 1000 strokes, the laminate sheet is subjected from the taffeta side( thereof to 1000 mm water column pressure for 60 seconds, examining the material for leaks. Materials leaking at two or more locations in a single scratch track are designated as “fail” (leaky).

### (5) Water Repellence Test

The sample is immersed for 24 hours in an aqueous solution at 40° C. containing a household kitchen cleanser in 0.10% concentration. Without wringing, it is then air dried for 5 hours. The laminate sheet is subjected from the taffeta side thereof to 1000 mm water column pressure for 60 seconds, examining the material for leaks. Materials leaking at two or more locations are designated as “fail” (leaky).

### (6) Ultraviolet Endurance Test

Using a QUV unit from Toyo Seiki, the sample is arranged with its coated face facing the light source, irradiated with UV for 60 hours, and then immersed for 24 hours in an aqueous solution at 40° C. containing a household kitchen cleanser in 0.1% concentration. Without wringing, it is then air dried for 5 hours and then subjected from the taffeta side thereof to 1000 mm water column pressure for 60 seconds, examining the material for leaks. Materials leaking at two or more locations are designated as “fail” (leaky).

### (7) Aging Test

The laminate sample is treated for 1000 hours in Geer oven held at 120° C. and then subjected to the abrasion test described above.

### (8) Relative Surface Frictional Force

In accordance with ASTM D1894, the dynamic coefficient of friction of the laminate sheet sample is measured, using two coated faces thereof as frictional surfaces. To simplify comparison, measurements are converted to relative values, assigning a value of “1” to the value in Example 1.

TABLE 1

| Test | Unit | Ex. 1 | Ex. 2 | Ex. 3 | Ex. 4 |
|---|---|---|---|---|---|
| Laminate water | g/m² · 24 h | 12000 | 11000 | 12000 | 6500 |
| vapor | | | | | |
| transmission | | | | | |
| Abrasion | strokes | 70000 | 70000 | 70000 | 70000 |
| | | no leaks | no leaks | no leaks | no leaks |
| Scratch | | | | | |
| transverse | g | 150 g | 150 g | 150 g | 150 g |
| | | leaky | leaky | leaky | leaky |
| longitudinal | g | ≧200 g | ≧200 g | 150 g | ≧200 g |
| | | no leaks | no leaks | leaky | no leaks |
| SUS ball abrasion | — | pass | pass | pass | pass |
| Water repellence | — | pass | pass | pass | pass |
| Ultraviolet | — | no leaks | no leaks | no leaks | no leaks |
| endurance | | | | | |
| Aging | strokes | 20000 | 20000 | 20000 | 20000 |
| | | no leaks | no leaks | no leaks | no leaks |
| Relative surface | — | 1 | 1.1 | 1.1 | — |
| frictional force | | | | | |

TABLE 2

| Test | | Unit | Cmp. 1 | Cmp. 2 | Cmp. 3 | Cmp. 4 | Cmp. 5 | Cmp. 6 |
|---|---|---|---|---|---|---|---|---|
| Laminate water | | g/m² · 24 h | 12000 | 3500 | 13000 | 4000 | 15000 | 6000 |
| vapor | | | | | | | | |
| transmission | | | | | | | | |
| Abrasion | | strokes | 500 | 10000 | 1000 | 10000 | 500 | 70000 |
| | | | leaky | leaky | leaky | leaky | leaky | no leaks |
| Scratch | tnsvs | g | ≦50 g | 150 g | ≦50 g | 50 g | ≦50 g | ≦50 g |
| | | | leaky | leaky | leaky | leaky | leaky | leaky |
| | Ingtd | g | ≦50 g | 200 g | ≦50 g | 200 g | ≦50 g | ≦50 g |
| | | | leaky | leaky | leaky | leaky | leaky | leaky |

| | | | | | | | |
|---|---|---|---|---|---|---|---|
| SUS ball | — | leaky | pass | leaky | pass | leaky | pass |
| abrasion | | | | | | | |
| Water | — | pass | pass | pass | pass, | leaky | pass |
| repellence | | | | | damp | | |
| Ultraviolet | — | leaky | leaky | leaky | leaky | leaky | leaky |
| endurance | | | | | | | |
| Aging | strokes | 1000 | 5000 | 1000 | 5000 | 500 | 20000 |
| | | leaky | leaky | leaky | leaky | leaky | no leaks |
| Relative | — | 1.5 | 1.4 | 1.4 | 1.2 | 0.4 | — |
| surface | | | | | | | |
| frictional force | | | | | | | |

Next, rainproof outerwear was fabricated using the laminate sheet samples from Example 1 and Comparative Example 1. These garments were worn for a 6-month period, and then subjected to a comparative evaluation of appearance and waterproofness of the laminate( sheet. Laminate sheet waterproofness was tested by subjected the laminate sheet from the taffeta side thereof to 1000 mm water column pressure for 60 seconds, and examining for leaks. Results are given in Table 3.

TABLE 3

| Test | Example 1 | Comparative Example 1 |
|---|---|---|
| Appearance | side panel skirt was | noticeable scratches on side |
| | scratched, but scratches | panel skirt and sleeves |
| | were not obvious | |
| Waterproofness | leaked in a total of 8 | numerous leaks in side panel |
| | locations | skirt, shoulders, and sleeves; |
| | | few leaks in back apart from |
| | | sleeves |

The rainproof outer garments fabricated from this material of Example 1 had markedly less damaged appearance and fewer leaks than the rainproof outer garments fabricated from the material of Comparative Example 1, demonstrating practical levels of durability. The rainproof outer garments produced in Example 1 each weighed 350 g, while rainproof outer garments of the same design and size constructed of the laminate sheet of Comparative Example 6 (three-layer structure composed of the material of Comparative Example 1 plus knit fabric laminated thereto) weighed 410 g.

From the above results it will be apparent that the laminate sheet materials herein offer dramatically improved durability against mechanical stresses while retaining moisture permeability and comfort, as well as dramatically improved durability against environmental stresses accompanying degradation with time.

Without intending to limit the scope of the present invention, the following examples illustrate how the present invention may be made and used:

While particular embodiments of the present invention have been illustrated and described herein, the present invention should not be limited to such illustrations and descriptions. It should be apparent that changes and modifications may be incorporated and embodied as part of the present invention within the scope of the following claims.

The invention claimed is:

1. A waterproof, moisture permeable composite film from 7 to 300 μm in thickness and comprising a porous hydrophobic film having a coating layer of a hydrophilic resin produced on one face thereof; wherein said hydrophilic resin coating layer is a thin film having depth such that when an electron microscopic image of the surface of said hydrophilic resin coating layer taken at 10,000× magnification with an electron microscope is viewed with the naked eye, the contours of said porous hydrophobic film matrix are visible through said hydrophilic resin coating layer over at least a portion of said hydrophilic resin coating layer; and wherein pores present on the surface of said porous film on the side thereof having the coating layer are infiltrated by hydrophilic resin continuous with said coating layer, while the surface of said porous film on the side thereof devoid of coating layer is not infiltrated by said hydrophilic resin and retains a porous structure, such that the composite film has water vapor transmission of at least 5000 g/m²·24 h.

2. The waterproof, moisture permeable composite film according to claim 1 wherein said hydrophilic resin infiltrates the interior of said porous hydrophobic film to a depth of from 5 to 30 μm.

3. The waterproof, moisture permeable composite film according to claim 1 wherein said porous hydrophobic film is a porous polytetrafluoroethylene film.

4. The waterproof, moisture permeable composite film according to claim 1 wherein said porous hydrophobic film is a porous polytetrafluoroethylene film whose pore surfaces are coated with a water- and oil-repellant polymer.

5. The waterproof, moisture permeable composite film according to claim 1 wherein said hydrophilic resin is a hydrophilic polyurethane resin.

6. The waterproof, moisture permeable composite film according to claim 1 wherein said hydrophilic resin is a hydrophilic polyurethane resin containing dye or pigment.

7. A waterproof, moisture permeable laminate sheet comprising waterproof, moisture permeable composite film according to claim 1; and fabric laminated to the hydrophobic face thereof.

8. A waterproof, moisture permeable laminate sheet comprising waterproof, moisture permeable composite film according to claim 1; and fabric laminated to both faces thereof.
